(19) United States
(12) Patent Application Publication
(10) Pub. No.: US 2026/0060333 A1
(43) Pub. Date: Mar. 5, 2026

(54) TEMPERATURE CONTROL METHOD AND SYSTEM APPLIED TO AEROSOL GENERATING DEVICE

(71) Applicant: SMOORE INTERNATIONAL HOLDINGS LIMITED, George Town (KY)

(72) Inventors: Xiangzhong LI, Shenzhen (CN); Lei MA, Shenzhen (CN); Xingfu ZHANG, Shenzhen (CN); Pengfei HUANG, Shenzhen (CN); Yubin XIAN, Shenzhen (CN); Xianwu DU, Shenzhen (CN); Hengheng DOU, Shenzhen (CN)

(21) Appl. No.: 19/383,507

(22) Filed: Nov. 7, 2025

Related U.S. Application Data
(63) Continuation of application No. PCT/CN2024/091478, filed on May 7, 2024.

(30) Foreign Application Priority Data
May 9, 2023 (CN) 202310519796.0

(51) Int. Cl. A24F 40/57; A24F 40/46; A24F 40/51; A24F 40/53

(52) U.S. Cl. CPC A24F 40/57; A24F 40/46; A24F 40/51; A24F 40/53

(57) ABSTRACT

A temperature control method applied to an aerosol generating device that includes a heating element and a housing, the heating element being powered on and heated up to generate infrared light to heat an aerosol generating substrate, the heating element and the housing being at least partially spaced apart, the infrared light capable of passing through the housing, the method including: obtaining a temperature signal of the housing; generating an adjustment signal by using a preset algorithm based on the temperature signal and a target temperature; and controlling a heating power of the heating element based on the adjustment signal so as to adjust a temperature of the heating element.

### CROSS-REFERENCE TO PRIOR APPLICATION

This application is a continuation of International Patent Application No. PCT/CN2024/091478, filed on May 7, 2024, which claims priority to Chinese Patent Application No. 202310519796.0, filed on May 9, 2023. The entire application of both applications is hereby incorporated by reference herein.

### FIELD

The present application relates to the field of heat-not-burn aerosol generating, and in particular, to a temperature control method and system applied to an aerosol generating device.

### BACKGROUND

In the field of heat-not-burn (HNB), common aerosol generating devices use a heating manner for generating an aerosol generating substrate based on a conduction transfer function. The aerosol generating substrate is inserted into a receiving cavity to provide power to a heating element in a receiving cavity. After the heating element converts the power into heat energy, the heating element atomizes the aerosol generating substrate at a high temperature to form aerosols. This heating manner transfers heat mainly by conduction, which can easily form a transfer temperature difference. Degrees of atomization of aerosol generating substrates at different distances from the heating element vary greatly, resulting in insufficient heating in early and late stages of atomization.

To improve the atomization performance, the aerosol generating substrates can be atomized in the atomization manner based on the heat radiation transfer function and the conduction transfer function. By supplying power to allow the heating element to heat up and emit infrared light, due to the penetrability of light waves, the infrared light can be uniformly transferred in the aerosol generating substrate, so temperatures of the aerosol generating substrates at different distances from the heating element are uniform. To better enhance a user experience, a heating temperature of the heating element needs to be controlled, thereby controlling the temperatures of the aerosol generating substrates to avoid situations such as burning caused by a high temperature or insufficient atomization caused by a low temperature.

### SUMMARY

In an embodiment, the present invention provides a temperature control method applied to an aerosol generating device that includes a heating element and a housing, the heating element being configured to be powered on and heat up to generate infrared light to heat an aerosol generating substrate, the heating element and the housing being at least partially spaced apart, the infrared light capable of passing through the housing, the method comprising: obtaining a temperature signal of the housing; generating an adjustment signal by using a preset algorithm based on the temperature signal and a target temperature; and controlling a heating power of the heating element based on the adjustment signal so as to adjust a temperature of the heating element.

### BRIEF DESCRIPTION OF THE DRAWINGS

Subject matter of the present application will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an aerosol generating device according to an embodiment of the present application;

FIG. 2 is a schematic structural diagram of a heating structure in the aerosol generating device shown in FIG. 1;

FIG. 3 is a cross-sectional view of the heating structure shown in FIG. 2;

FIG. 4 is a schematic structural exploded diagram of the heating structure shown in FIG. 2;

FIG. 5 is a schematic block diagram of the temperature measurement principle of an aerosol generating device according to the present application;

FIG. 6 is a circuit diagram of one embodiment shown in FIG. 5;

FIG. 7 is a circuit diagram of another embodiment shown in FIG. 5;

FIG. 8 is a schematic diagram of temperature changes of a heating element;

FIG. 9 is a schematic structural diagram of an aerosol generating device according to another embodiment of the present application;

FIG. 10 is a schematic structural diagram of a heating structure shown in FIG. 9 in another angle;

FIG. 11 is a cross-sectional view of a heating structure shown in FIG. 9;

FIG. 12 is a schematic structural exploded diagram of a heating structure shown in FIG. 9;

FIG. 13 is a schematic diagram of mounting of a thin film temperature sensor according to the present application; and

FIG. 14 is a transverse cross-sectional view of the heating structure shown in FIG. 4.

### DETAILED DESCRIPTION

In an embodiment, the present invention provides a temperature control method and system applied to an aerosol generating device.

In an embodiment, the present invention provides a temperature control method applied to an aerosol generating device, which is applied to the aerosol generating device. The aerosol generating device includes a heating element and a housing. The heating element is configured to be powered on and heat up to generate infrared light that heats an aerosol generating substrate. The heating element and the housing wall of the housing are at least partially spaced apart. The housing wall of the housing allows the infrared light to pass through. The method includes the following steps:
obtaining a temperature signal of the housing;
generating an adjustment signal by using a preset algorithm based on the temperature signal and a target temperature; and
controlling the heating power of the heating element based on the adjustment signal, to adjust the temperature of the heating element.

Preferably, the controlling the heating power of the heating element based on the adjustment signal, to adjust the temperature of the heating element includes:
in a first stage, controlling the heating power of the heating element based on the adjustment signal to increase the temperature of the heating element from an initial temperature to a first temperature; and
in a second stage, controlling the heating power of the heating element based on the adjustment signal to gradually decrease the temperature of the heating element from the first temperature.

Preferably, the first temperature is between 500° C. and 1300° C.

Preferably, a user is prompted to take a puff within a first preset range at the end of the first stage, and heating is stopped within a second preset range at the end of the second stage.

Preferably, the duration of the first stage does not exceed 20 seconds, and the duration of the second stage does not exceed 360 seconds.

Preferably, whether the temperature signal indicates that a temperature decrease exceeds a threshold within a preset time range is determined; if the temperature decrease exceeds the threshold within the preset time range, a recorded puff count is increased by one; and if temperature decrease does not exceed the threshold within the preset time range, the recorded puff count remains unchanged.

The present application further provides a temperature control system applied to an aerosol generating device, which is applied to the aerosol generating device. The aerosol generating device includes a heating element and a housing; the heating element is configured to be powered on and heat up to generate infrared light that heats an aerosol generating substrate; the heating element and the housing wall of the housing are at least partially spaced apart; and the housing wall of the housing allows the infrared light to pass through.

The temperature control system includes a temperature measurement unit, a temperature measurement module, an adjustment signal generation module, and a power control module.

The temperature measurement unit is arranged on the inner wall or the outer wall of the housing to detect the temperature of the housing.

The temperature measurement module is configured to monitor the temperature of the temperature measurement unit in real time to obtain a temperature signal of the housing.

The adjustment signal generation module is configured to generate an adjustment signal by using a preset algorithm based on the temperature signal and the target temperature.

The power control module is configured to control the heating power of the heating element based on the adjustment signal, to adjust the temperature of the heating element.

Preferably, the power control module is further configured to:
in a first stage, control the heating power of the heating element based on the adjustment signal to increase the temperature of the heating element from an initial temperature to a first temperature; and
in a second stage, control the heating power of the heating element based on the adjustment signal to gradually decrease the temperature of the heating element from the first temperature.

Preferably, the first temperature is between 500° C. and 1300° C.; and
the duration of the first stage does not exceed 20 seconds, and the duration of the second stage does not exceed 360 seconds.

Preferably, the temperature measurement unit includes a first temperature sensor or a second temperature sensor;
the first temperature sensor includes a thin film temperature sensor or a thermistor; and
the second temperature sensor includes a thermocouple.

Preferably, the first temperature sensor is connected in series with a first resistor and a temperature measurement switch;
the first temperature sensor is configured to detect the temperature of the housing; and
the temperature measurement switch is configured to be turned on or turned off based on an input driving signal, to adjust the electrical energy provided to the first temperature sensor.

Preferably, the second temperature sensor is connected to the temperature measurement module;
the second temperature sensor is configured to generate a sensing signal based on the temperature of the housing; and
the temperature measurement module is configured to generate and output the temperature signal based on the sensing signal.

Preferably, the power control module includes a second resistor, a third resistor, an N-channel metal oxide semiconductor (NMOS) transistor, and a P-channel metal oxide semiconductor (PMOS) transistor;
the gate of the NMOS transistor is connected to the adjustment signal generation module, receives the adjustment signal, and is grounded through the second resistor; the source of the NMOS transistor is grounded;
the gate of the PMOS transistor is connected to the drain of the NMOS transistor; the drain of the PMOS transistor is connected to an input voltage; the source of the PMOS transistor is connected to the heating element to adjust the heating power of the heating element based on the adjustment signal; and
the third resistor is connected between the drain and gate of the PMOS transistor.

Preferably, the heating element is located inside the housing; the heating element includes a heating base and an infrared radiation layer coated on the heating base; the heating element is configured to excite, after being powered on, the infrared radiation layer to generate the infrared light; and the housing is at least partially configured to be inserted into an aerosol generating substrate.

Preferably, the temperature measurement unit includes a first temperature sensor or a second temperature sensor;
the first temperature sensor includes a thin film temperature sensor or a thermistor; the first temperature sensor is arranged on the outer wall of the housing;
the second temperature sensor includes a thermocouple; and the second temperature sensor is arranged on the inner wall of the housing.

Preferably, the heating element is arranged at the periphery of the housing in a spacing manner; and the inside of the housing is hollow and forms a second accommodating cavity for accommodating the aerosol generating substrate.

Preferably, the housing includes a first tube body and a second tube body sleeving the periphery of the first tube body;
a gap is reserved between the first tube body and the second tube body; the gap forms a first accommodating cavity for accommodating the heating element;
the heating element is arranged at the periphery of the first tube body and is spaced apart from the outer wall of the first tube body; a second accommodating cavity for heating the aerosol generating substrate is formed on the inner side of the first tube body;
the heating element includes a heating base and an infrared radiation layer coated on the heating base; and the heating element is configured to excite, after being powered on, the infrared radiation layer to generate the infrared light.

Preferably, the temperature measurement unit includes a first temperature sensor or a second temperature sensor;
the first temperature sensor includes a thin film temperature sensor or a thermistor; the first temperature sensor is arranged on the inner wall of the first tube body;
the second temperature sensor includes a thermocouple; and the second temperature sensor is arranged on the outer wall of the first tube body.

Implementing the present application has the following beneficial effects: by obtaining the temperature signal of the housing, generating the adjustment signal based on the temperature signal and the target temperature, and controlling the heating power of the heating element based on the adjustment signal, to adjust the temperature of the heating element, the temperature of the aerosol generating substrate is stably adjusted; the atomization stability can be improved; and a user experience can be enhanced.

To provide a clearer understanding of the technical features, objectives, and effects of the present application, specific implementations of the present application are described in detail with reference to the accompanying drawings. It should be noted that unless otherwise expressly specified and limited, the terms “connect”, “arrange”, and the like should be understood in a broad sense, such as, a fixed connection, a detachable connection, an integrated connection, a mechanical connection, an electrical connection, a direct connection, an indirect connection through an intermediate medium, an internal communication of two elements, or interaction between two elements. The terms such as “first”, “second”, and “third” are only for the convenience of describing the technical solution and should not be understood as indicating or implying relative importance or implying the number of technical features indicated. Therefore, the features limited by “first”, “second” and “third” may explicitly or implicitly include one or more of these features. A person of ordinary skill in the art may understand the specific meanings of the foregoing terms in the present application according to specific situations.

In the following description, for the purpose of description rather than limitation, specific details such as the specific system structure and technology are provided to thoroughly understand the embodiments of the present application. However, a person skilled in the art should be aware that the present application may be implemented in other embodiments without these specific details. In other cases, detailed descriptions of well-known systems, apparatuses, circuits, and methods are omitted to avoid unnecessary details hindering the description of the present application.

The present application relates to a temperature control method and system applied to an aerosol generating device. The temperature control system may be configured to perform the temperature control method applied to the aerosol generating device disclosed in the embodiments of the present application, to adjust the temperature of a heating element, so as to stably adjust the temperature of the aerosol generating substrate. The atomization stability can be improved, and a user experience can be enhanced.

In one embodiment, the aerosol generating device 100 can heat an aerosol generating substrate by using a heat-not-burn manner. In some embodiments, the aerosol generating substrate can be arranged on the aerosol generating device 100 in a pluggable manner, and the aerosol generating substrate can be cylindrical. Specifically, the aerosol generating substrate can be a filamentous, sheet-like, granular, or integrally formed solid material made from leaves and/or stems of plant (such as tobacco), and an aroma component can be further added into the solid material.

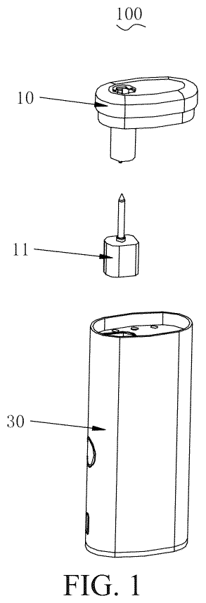

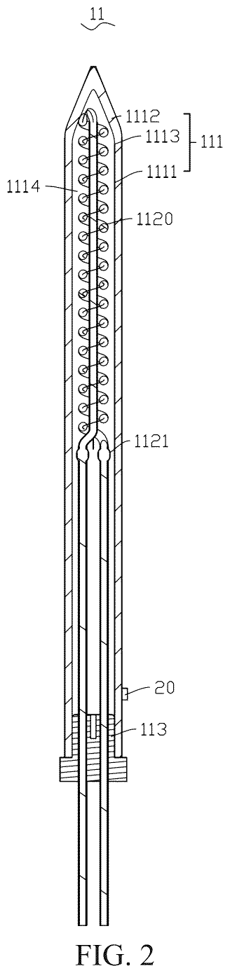

Further, as shown in FIG. 1 and FIG. 2, the aerosol generating device 100 includes: an upper cover assembly 10, a heating structure 11, a control portion 30, and the temperature control system of the present application. The temperature control system includes a temperature measurement unit 20, a temperature measurement module 31, an adjustment signal generation module 32, and a power control module 33. The temperature measurement module 31, the adjustment signal generation module 32, and the power control module 33 are arranged in the control portion 30.

The heating structure 11 can be partially inserted into the aerosol generating substrate. Specifically, the heating structure 11 can be at least partially inserted into a medium section of the aerosol generating substrate, and generate infrared light in a powered-on state to heat the medium section of the aerosol generating substrate. After being heated, the medium section of the aerosol generating substrate generates aerosols.

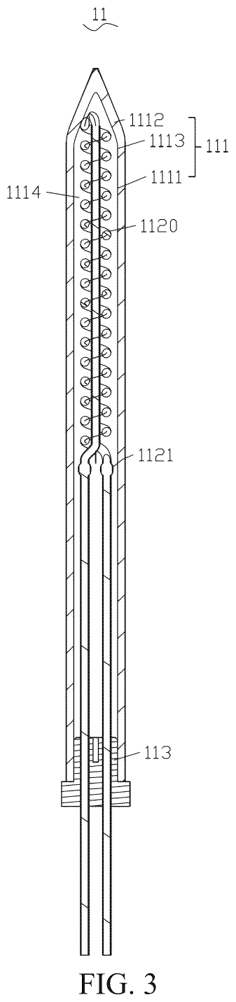

As shown in FIG. 2 to FIG. 4, in this embodiment, the heating structure 11 is a central heating structure. The heating structure 11 includes a heating element 112, a housing 111, and a base 113. The heating element 112 and the housing 111 are at least partially spaced apart. The heating element 112 is located inside the housing 111. The housing 111 is at least partially configured to be inserted into the aerosol generating substrate. The heating element 112 is powered on to heat up and generate infrared light. For example, a gap 1114 is reserved between the housing 111 and the heating element 112. The gap 1114 can be filled with air. Certainly, it can be understood that in other embodiments, the gap 1114 can also be filled with reducing gas or inert gas. The heating element 112 is at least partially accommodated in the housing 111, and the aerosol generating substrate can be heated through the infrared light generated by the heating element 112. Specifically, the housing 111 can allow the infrared light generated by the heating element 112 to pass through, so that the infrared light generated by the heating element 112 is at least partially absorbed by the aerosols to heat the aerosol generating device. The base 113 is arranged at an opening 1110 of the housing 111.

In this embodiment, the housing 111 can be made of a glass material. For example, the housing 111 can be made of quartz glass. Alternatively, in some other embodiments, the housing 111 is not limited to the quartz glass and can also be other window materials that allow infrared light to pass through, such as infrared-transmission glass, transparent ceramic, and diamond.

In this embodiment, the housing 111 is a hollow tube, that is, a tube made of transparent quartz glass. The housing 111 is of a longitudinal structure with two end portions distributed in an axial direction. The longitudinal structure refers to a structure in which the size of the housing 111 in one direction (such as a length direction) is larger than the size in another direction (such as a thickness direction). Specifically, the housing 111 includes a tubular body 1111 having a circular cross section and a pointed-top structure 1112 arranged at one end of the tubular body 1111. Certainly, it can be understood that, in some other embodiments, the cross section of the tubular body 1111 is not limited to being circular. The tubular body 1111 is of a hollow structure provided with an opening 1110 in one end. The pointed-top structure 1112 is arranged at one end of the tubular body 1111 away from the opening 1110. By providing the pointed-top structure 1112, the heating structure 11 is at least partially plugged into the aerosol generating substrate. In this embodiment, a first accommodating cavity 1113 is formed on the inner side of the housing 111, and the first accommodating cavity 1113 is a columnar cavity. In this implementation, the tubular body 1111 is a cylinder, and the pointed-top structure 1112 is a cone. In another implementation, the housing 111 may alternatively have another form, such as a triangular prism, a cuboid, or another shape. In some other embodiments, the heating element 112 may be arranged at the periphery of the housing 111 in a spacing manner, and a second accommodating cavity for accommodating the aerosol generating substrate may be formed on the inner side of the housing 111.

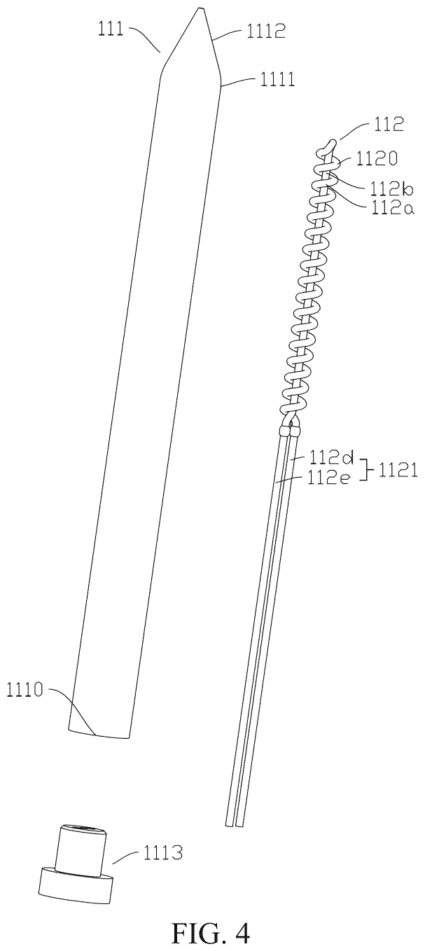

As shown in FIG. 4, in this embodiment, one heating element 112 may be provided, which may be provided lengthwise and has a first free end 112d and a second free end 112e. In this embodiment, the heating element 112 is a strip (a solid circular wire) with a circular cross section. The heating element 112 is at least partially bent to form a columnar heating portion 1120 as a whole. Specifically, the heating element 112 may be bent to form a spirally columnar heating portion 1120. It can be understood that in some other embodiments, the heating element 112 is not limited to being the strip, and may be a longitudinal sheet or mesh. The heating portion 1120 is not limited to being columnar, but can be sheet-like, mesh-like, or strip-shaped. In some embodiments, the heating element 112 may be wound to form the heating portion 1120 having a single-spiral shape, a double-spiral shape, an M shape, an N shape, or another shape. Certainly, it can be understood that in some other embodiments, one, two, or more heating elements 112 may be provided. It should be noted that in some other embodiments, the heating element 112 may alternatively be a metal sheet or a metal needle.

In this embodiment, the heating portion 1120 includes a first heating portion 112a and a second heating portion 112b; and one end of the first heating portion 112a is connected to one end of the second heating portion 112b. In this embodiment, the first heating portion 112a and the second heating portion 112b are of an integrally formed structure, and may be formed by bending one heating element 112. It can be understood that in some other embodiments, the first heating portion 112a and the second heating portion 112b may alternatively be of a split structure, and the first heating portion 112a and the second heating portion 112b may be two heating elements 112 that are connected together in a manner of welding, riveting, and the like. It can be understood that in some other embodiments, the second heating portion 112b may alternatively be omitted, and may be replaced by an apyretic conductive rod.

In this embodiment, a conductive portion 1121 is arranged at one end of the heating portion 1120. The conductive portion 1121 is connected to the heating portion 1120, may be led out from one end portion of the housing 111, and may be threaded through the base 113 to be conductively connected to a power supply assembly in the control portion 30. In this embodiment, two conductive portions 1121 may be provided. The two conductive portions 1121 may be spaced from each other and respectively connected to the heating portion 1120, and are threaded through the housing 111 from the same end of the housing 111. In this embodiment, the conductive portion 1121 may be fixed to the heating portion 1120 by welding. Certainly, it can be understood that in some other embodiments, the heating portion 1120 may be integrally formed with the conductive portions 1121, and the first free end 112d and the second free end 112e of the heating element 112 may respectively form two conductive portions 1121. That is, the first free end 112d of a first heating portion 112a forms one conductive portion 1121; and the second free end 112e of a second heating portion 112b forms the other conductive portion 1121. In some other embodiments, the conductive portion 1121 may be a lead wire with resistance less than that of the heating portion, such as a lead wire made of a silver or aluminum material, and the conductive portion 1121 may be welded with the heating portion 1120. Certainly, it can be understood that in some other embodiments, the conductive portion 1121 is not limited to being a lead wire, and it may be of another conductive structure.

As shown in FIG. 14, in this embodiment, the heating portion 1120 includes a heating base 1122 and an infrared radiation layer 1124. The heating base 1122 may generate heat in a powered-on state. The infrared radiation layer 1124 is coated on the outer surface of the heating base 1122. In the powered-on heating state, the heating base 1122 may excite the infrared radiation layer 1124 to generate and radiate infrared light. In this embodiment, the heating base 1122 and the infrared radiation layer 1124 are distributed in a concentric circle on the cross section of the heating portion 1120.

In this embodiment, the heating base 1122 may have an overall strip-like shape, and may have a circular cross section. Specifically, the heating base 1122 may be a heating wire. Certainly, it can be understood that in some other embodiments, the heating base 1122 may alternatively be sheet-like. That is, the heating base 1122 may be a heating sheet. The heating base 1122 includes a metal base having a high-temperature oxidation resistance, and the metal base may be a metal wire. Specifically, the heating base 1122 may be a metal material that has good high-temperature oxidation resistance, high stability, difficult deformation, and the like, such as a nichrome base (such as a nichrome wire) and an aludirome base (such as an aludirome wire). In this embodiment, the radial size of the heating base 1122 may be 0.15 mm to 0.8 mm. The metal wire may be bent or wound into various shapes, such as a spiral shape, a mesh shape, an M shape, or an N shape. The bent or wound heating element has an overall columnar shape, a spiral segment, a mesh shape, or other three-dimensional or planar shape with bends.

In this embodiment, the heating portion 1120 further includes an oxidation resistance layer 1123, and the oxidation resistance layer 1123 is formed between the heating base 1122 and the infrared radiation layer 1124. Specifically, the oxidation resistance layer 1123 may be an oxide film. The heating base 1122 is subjected to high-temperature heat treatment, and a dense oxide film is formed on the surface of the heating base. The oxide film forms the oxidation resistance layer 1123. Certainly, it can be understood that in some other embodiments, the oxidation resistance layer 1123 is not limited to including the oxide film formed by itself. In some other embodiments, the oxidation resistance layer may be an oxidation resistance coating applied to the outer surface of the heating base 1122. By forming the oxidation resistance layer 1123, it can be ensured that the heating base 1122 is not or rarely oxidized when heated in an air environment, thereby improving the stability of the heating base 1122. Thus, it is unnecessary to vacuumize the first accommodating cavity 1113 or fill the first accommodating cavity 1113 with reducing gas, thereby simplifying an assembling process of the entire heating structure 11 and saving the manufacturing costs. In this embodiment, the thickness of the oxidation resistance layer 1123 may be selectively 1 μm to 150 μm. When the thickness of the oxidation resistance layer 1123 is less than 1 μm, the heating base 1122 is easily oxidized. When the thickness of the oxidation resistance layer 1123 is greater than 150 μm, heat conduction between the heating base 1122 and the infrared radiation layer 1124 may be seriously affected.

In this embodiment, the infrared radiation layer 1124 may be an infrared layer. The infrared layer may be formed on one side of the oxidation resistance layer 1123 away from the heating base 1122 by an infrared layer forming base through high-temperature heat treatment. In this embodiment, the infrared layer forming base may be a silicon carbide base, a spinel substrate base, or a composite base thereof. Certainly, it can be understood that in some other embodiments, the infrared radiation layer 1124 is not limited to being the infrared layer. In some other embodiments, the infrared radiation layer 1124 may be a composite infrared layer. In this embodiment, the infrared layer may be formed on the side of the oxidation resistance layer 1123 away from the heating base 1122 in a manner of dip coating, spray coating, brush coating, or the like. The thickness of the infrared radiation layer 1124 may be 10 μm to 300 μm. When the infrared radiation layer 1124 has the thickness of 10 μm to 300 μm and a good infrared light effect, the aerosol generating substrate 200 provides high atomization efficiency and an improved vaping experience. Certainly, it can be understood that in some other embodiments, the thickness of the infrared radiation layer 1124 is not limited to 10 μm to 300 μm.

In this embodiment, unlike the heating element of the existing electronic cigarette, the maximum operating temperature range of the heating element 112 may be 500° C. to 1300° C. That is, during the entire operating period, the maximum operating temperature of the heating element 112 may be any temperature in the range of 500° C. to 1300° C., and may be specifically determined based on a temperature control requirement. However, the maximum operating temperature of the heating element in the existing art is usually within 400° C.

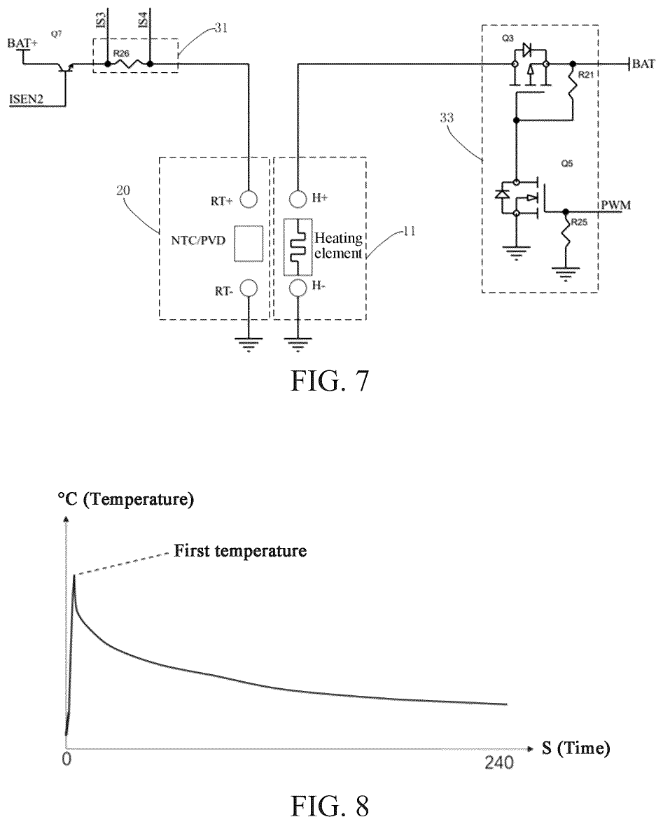

Specifically, as shown in FIG. 8, in this embodiment, the heating process of the heating element 112 includes a first stage and a second stage. In the first stage, the temperature of the heating element increases from an initial temperature to a first temperature. In the second stage, the temperature of the heating element gradually decreases from the first temperature. The first temperature is between 500° C. and 1300° C. That is, the first temperature can be 500° C. or 1300° C., or any value between 500° C. and 1300° C. The duration of the first stage does not exceed 20 seconds, and the duration of the second stage does not exceed 360 seconds. The first stage can be a preheating stage, with the maximum temperature ranging from 700° C. to 1300° C. At this temperature, the aerosol generating substrate can be preheated within very short time, thereby ensuring the aerosol amount and the vaping experience for about the first three puffs of a user. Specifically, in the powered-on state, the temperature of the heating element 112 can quickly increase from the room temperature to the first temperature, with the duration not exceeding 20 seconds. In some cases, the duration can be shortened to 3 to 5 seconds. The second stage can be a puff stage after the aerosol generating substrate is preheated and normally generates aerosols inhaled by the user. Its duration generally does not exceed 360 seconds. As shown in FIG. 8, it is 240 seconds. The temperature of the heating element gradually decreases from about the first temperature. Certainly, it can be understood that in some other embodiments, the heating process of the heating element 112 is not limited to being divided into two stages. For example, the puff stage can be further divided into a middle puff stage and a late puff stage, and corresponding heating temperatures are set. Due to the existence of the gap 1114, the surface temperature of the housing 111 can be controlled below 350° C., and the atomization temperature of the entire aerosol generating substrate can be controlled between 300° C. and 350° C., thus implementing precise atomization of the aerosol generating substrate mainly within an infrared band of 2 μm to 5 μm. In the second stage, the temperature of the heating element is controlled to gradually decrease from the first temperature, which is beneficial for gradually increasing the wavelength of the infrared light generated by the heating element and making the penetrability of the infrared light higher. In another aspect, controlling the temperature of the heating element in the puff stage to decrease can reduce the conduction function of the housing on the aerosol generating substrate, and prevent the excessively high temperature of the aerosol generating substrate close to the pipe wall from causing a burnt smell or a peculiar smell.

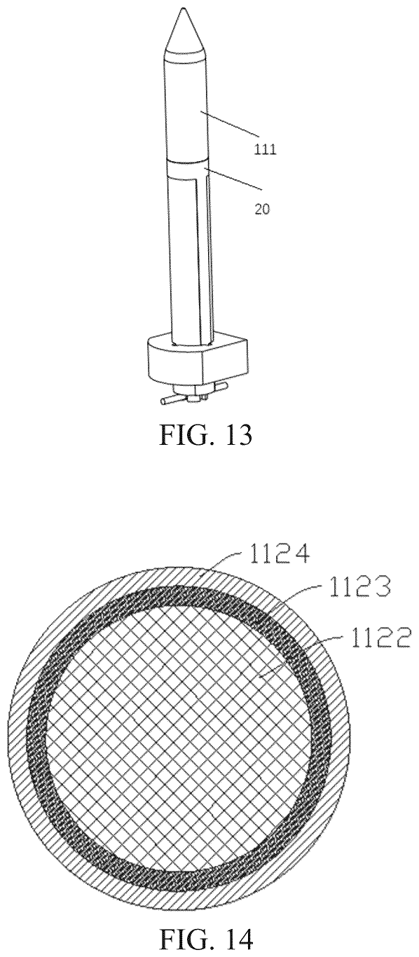

In this embodiment, the temperature measurement unit 20 is arranged on the inner wall or the outer wall of the housing 111 to detect the temperature of the housing 111, and includes a first temperature sensor or a second temperature sensor. Referring to FIG. 13, the first temperature sensor is arranged on the outer wall of the housing of the central heating structure, and includes a thin film temperature sensor (a resistive temperature measurement film) or a thermistor formed on the housing in a manner of screen printing, physical vapor deposition (PVD), or the like. Due to the ultra-thin, soft, and easily deformable characteristics of the thin film temperature sensor, the thin film temperature sensor can be smoothly adhered to the housing wall without affecting the insertion into the aerosol generating substrate. It can be understood that in some other embodiments, when the thin film temperature sensor includes a material that is prone to oxidation and erosion, a protective layer can be formed by electroplating one or more of gold, nickel, and glass to prevent oxidation erosion and prolong the service life of the thin film temperature sensor.

The second temperature sensor is arranged on the inner wall of the housing of the central heating structure, and includes a thermocouple. Since the thermocouple is isolated from the aerosol generating substrate through the housing 111, the thermocouple is not affected by insertion friction of the aerosol generating substrate and residual corrosion caused by atomization, and the thermocouple has the longer working life and the higher stability. No external power supply is required during measurement performed by the thermocouple, so that it is convenient to use, and the temperature can be directly measured and converted into a sensing signal.

Specifically, in this embodiment, the temperature measurement unit 20 can employ a thermocouple, a temperature measurement film, a negative temperature coefficient thermistor (NTC), a positive temperature coefficient thermistor (PTC), or the like. Certainly, it can be understood that in other embodiments, the temperature measurement unit 20 is not limited to the above temperature sensors, and can employ other sensors or temperature measurement elements for detection, as long as they can accurately measure the temperature of the housing.

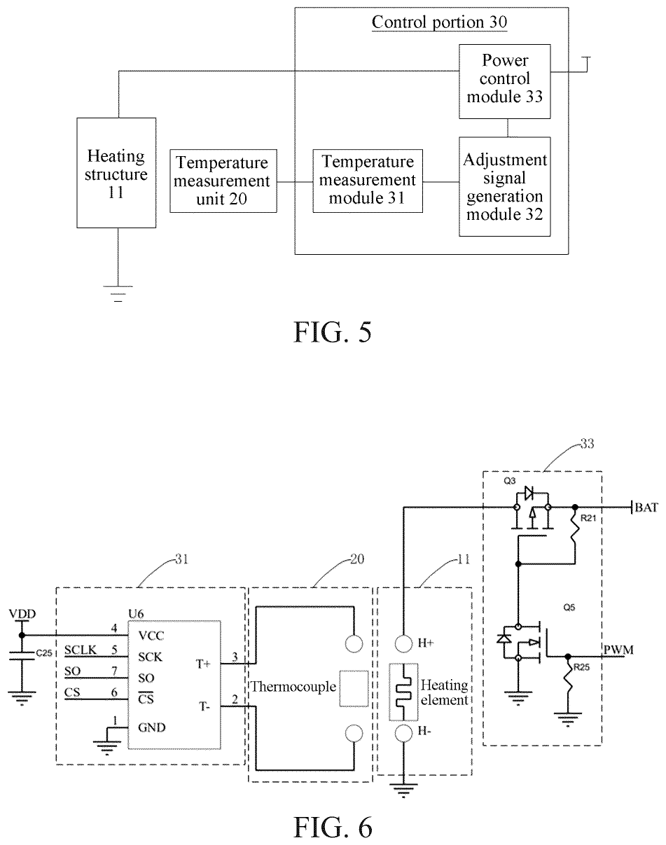

Further, as shown in FIG. 5, in this embodiment, the temperature measurement module 31 is connected to the temperature measurement unit 20 to monitor the temperature of the temperature measurement unit 20 in real time to obtain a temperature signal of the housing 111. In this embodiment, when the temperature measurement unit 20 employs the thermocouple, the temperature measurement module 31 can employ a thermocouple detection integrated circuit (IC). Specifically, the thermocouple detection IC is connected to the temperature measurement unit 20 to generate and output a corresponding temperature signal based on a sensing signal generated by the temperature measurement unit 20.

Further, in this embodiment, the adjustment signal generation module 32 may include, but is not limited to, a microcomputer, a chip, and the like, to generate an adjustment signal by using a preset algorithm based on the temperature signal and a target temperature. The target temperature can be the preset target temperature of the housing or the preset target temperature of the heating element. When the target temperature of the housing is used, the adjustment signal is generated based on the target temperature of the housing and the measured actual temperature of the housing. When the target temperature of the heating element is used, the actual temperature of the heating element is obtained based on the actual temperature of the housing, and then the adjustment signal is generated based on the actual temperature of the heating element and the target temperature of the heating element. The preset algorithm can employ, but is not limited to, a proportion integration differentiation (PID) algorithm, a neural network, a fuzzy control algorithm, or the like. The generated adjustment signal can be a pulse width modulation (PWM) signal, and the output power of the power control module 33 is adjusted by adjusting the duty cycle of the PWM signal.

In addition, the adjustment signal generation module 32 can effectively adjust temperature changes in the first stage and the second stage of the heating process of the heating element, further adjust the heating temperature of the aerosol generating substrate, and control the atomization effect of the aerosol generating substrate. Furthermore, within a first preset range at the end of the first stage, a user is prompted to take a puff in a manner of voice, vibration, flashing of an indicator light, or the like, to enhance the user experience. Within a second preset range at the end of the second stage, the heating element is controlled to stop heating. The first preset range and the second preset range are determined based on a temperature control requirement and can be set to 1 to 3 seconds.

Optionally, the adjustment signal generation module 32 is further configured to detect a puff count: determining whether the temperature signal indicates that a temperature decrease exceeds a threshold within a preset time range; if the temperature decrease exceeds the threshold within the preset time range, increasing a recorded puff count by one; and if temperature decrease does not exceed the threshold within the preset time range, maintaining the recorded puff count unchanged. When the aerosol generating device is activated, the recorded puff count is 0. When it is monitored that the temperature signal decreases uncontrollably within a preset time range t and a decrease amplitude is greater than a threshold, it is determined that there is a puffing action, and the recorded puff count is increased by one.

Further, in this embodiment, the power control module 33 is connected to the heating element 112 to control the heating power of the heating element based on the adjustment signal, thereby adjusting the temperature of the heating element. The power control module 33 receives the adjustment signal and adjusts electrical energy provided to the heating element 112 based on the control performed by the adjustment signal generation module 32, thus controlling the heating power of the heating element to adjust the temperature of the heating element. Specifically, referring to FIG. 8, the power control module 33 is configured to control the heating power of the heating element based on the adjustment signal, so that the temperature of the heating element increases from the initial temperature to the first temperature. In the second stage, the heating power of the heating element is controlled based on the adjustment signal to cause the temperature of the heating element to gradually decrease from the first temperature. The first temperature is between 500° C. and 1300° C., which means that the first temperature can be 500° C. or 1300° C., or any value between 500° C. and 1300° C. The duration of the first stage does not exceed 20 seconds, and the duration of the second stage does not exceed 360 seconds. Certainly, it can be understood that in some other embodiments, the second stage can be further divided into a middle puff stage and a late puff stage.

In this embodiment, the second temperature sensor is connected to the temperature measurement module 31. The second temperature sensor is configured to generate a sensing signal based on the temperature of the housing. The temperature measurement module 31 is configured to generate and output a temperature signal based on the sensing signal. As shown in FIG. 6, when the temperature measurement unit 20 is the second temperature sensor, namely the thermocouple, the temperature measurement module 31 includes a thermocouple detection IC (U6). The fourth pin of the thermocouple detection IC is connected to a VDD and is grounded through a capacitor C25. The second pin of the thermocouple detection IC is connected to the second end of the thermocouple. The third pin of the thermocouple detection IC is connected to the first end of the thermocouple. The fifth pin of the thermocouple detection IC is connected to the 26^{th} pin (of the adjustment signal generation module 32. The seventh pin of the thermocouple detection IC is connected to the 27^{th} pin of the adjustment signal generation module 32. In this embodiment, the adjustment signal generation module 32 detects the temperature of the thermocouple in real time through the thermocouple detection IC, thus implementing the real-time detection on the temperature of the housing, implementing the real-time detection on the temperature of the heating element, and determining, based on a temperature change of the thermocouple within the preset time range, whether a user has a puffing action, to detect a puff count.

As shown in FIG. 6, in this embodiment, the power control module 33 includes an NMOS transistor Q5 and a PMOS transistor Q3. The source of the NMOS transistor Q5 is grounded. The gate of the NMOS transistor Q5 is connected to the twelfth pin of the adjustment signal generation module 32 to receive a PWM signal. The drain of the NMOS transistor Q5 is connected to the gate of the PMOS transistor Q3. The source of the PMOS transistor Q3 is connected to a battery (BAT). The drain of the PMOS transistor Q3 is connected to the positive electrode of the heating element 112, and the negative electrode of the heating element 112 is grounded. In this embodiment, the NMOS transistor Q5 drives the PMOS transistor Q3 to be turned on/off based on the PWM signal output by the adjustment signal generation module 32, to control the electrical energy provided by the battery to the heating element 112. Longer turning-on time of the PMOS transistor Q3 indicates the higher heating power of the heating element 112, the higher temperature of the heating element 112, and the shorter wavelength of the generated infrared light. Further, the power control module 33 further includes a second resistor R25 and a third resistor R21 that are configured to protect the circuit. The gate of the NMOS transistor Q5 is grounded through the second resistor R25, and the third resistor R21 is connected between the drain and gate of the PMOS transistor Q3.

In this embodiment, the first temperature sensor is connected in series to a first resistor and a temperature measurement switch. The first temperature sensor is configured to detect the temperature of the housing. The temperature measurement switch is configured to be turned on or turned off based on an input driving signal, to adjust the electrical energy provided to the first temperature sensor. When the temperature measurement unit 20 employs the thin film temperature sensor or the thermistor as the first temperature sensor, the temperature measurement module 31 can be implemented through a temperature measurement circuit, where the temperature measurement circuit can be implemented through a resistor and the temperature measurement switch can be implemented through a triode. Specifically, as shown in FIG. 7, the positive end of the thin film temperature sensor is connected to the second end of the first resistor R26, and the second end of the first resistor R26 is further connected to the fourth pin of the adjustment signal generation module 32. The first end of the first resistor R26 is connected to the sixth pin of the adjustment signal generation module 32, and the first end of the first resistor R26 is further connected to the emitter of a triode Q7. The collector of the triode Q7 is connected to the positive end (BAT+) of the battery, and the base of the triode Q7 is connected to the third pin of the adjustment signal generation module 32. The adjustment signal generation module 32 outputs a driving signal to the triode Q7 to control turning on or turning off of the triode Q7, thereby controlling and adjusting the electrical energy provided to the thin film temperature sensor/thermistor through the triode Q7.

In this embodiment, the adjustment signal generation module 32 collects a voltage at the two ends of the first resistor R26, obtains a voltage at two ends of the thin film temperature sensor/thermistor by subtracting the voltage at the two ends of the first resistor R26 from a supply voltage (BAT), obtains a current flowing through the first resistor R26 by dividing the voltage at the two ends of the first resistor R26 by the resistance value of the first resistor R26 (the current flowing through the first resistor R26 is equal to a current flowing through the thin film temperature sensor/thermistor), and finally obtains the resistance value of the thin film temperature sensor/thermistor, thus detecting the temperature of the thin film temperature sensor/thermistor.

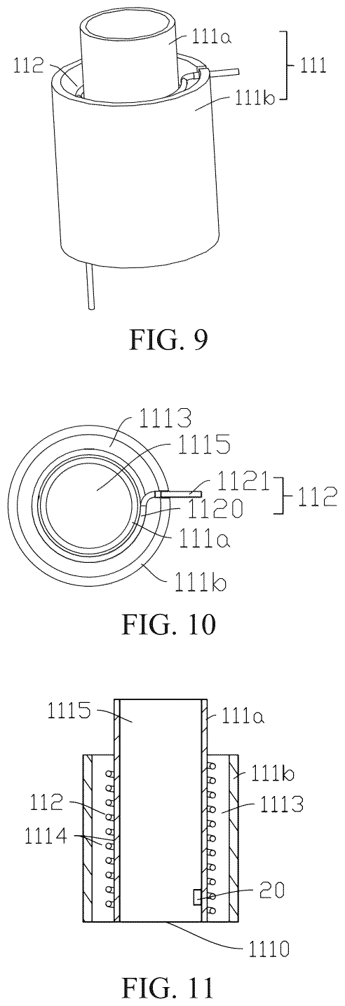

FIG. 9 to FIG. 12 show an aerosol generating device 100 according to a second embodiment of the present application. In this embodiment, the housing 111 includes a first tube body 111b and a second tube body 111b. The first tube body 111b is of a hollow structure with two ends that are connected to each other. The first tube body 111a may be cylindrical, the inner diameter of which may be slightly greater than the outer diameter of an aerosol generating substrate. A second accommodating cavity 1115 may be formed on the inner side of the first tube body 111a and is configured to: accommodate the aerosol generating substrate and form a heating space for heating a medium section of the aerosol generating substrate. The axial length of the first tube body 111a may be greater than the axial length of the second tube body 111b. The second tube body 111b may sleeve the periphery of the first tube body 111a. The second tube body 111b may be cylindrical. The radial size of the second tube body 111b may be greater than the radial size of the first tube body 111a. That is, a gap is reserved between the second tube body 111b and the first tube body 111a. The gap can form a first accommodating cavity 1113. The first accommodating cavity 1113 is configured to accommodate the heating element 112. The heating element 112 is arranged at the periphery of the first tube body 111a and is spaced apart from the outer wall of the first tube body 111a. In some embodiments, the heating element 112 is wound at the periphery of the first tube body 111a, and a gap 1114 is reserved between the entire heating element 112 and the inner wall of the second tube body 111b, as well as the outer wall of the first tube body 111a (that is, the heating element 112 is at least partially spaced apart from the housing 111). This can form a temperature difference between the inner wall of the first accommodating cavity 1113 and the heating element 112, thereby playing a heat isolation role. In some embodiments, a reflective layer may be arranged the inner wall of the second tube body 111b to reflect the heat of the heating element 112 and radiate the heat to the aerosol generating substrate 200, thus improving the heating efficiency.

In some other embodiments, the heating element 112 is not limited to being completely spaced apart from the first tube body 111a or the second tube body 111b. In some other embodiments, the heating element 112 may alternatively be partially spaced apart from the first tube body 111a. The radial size of a section of the heating portion 1120 may be equivalent to the outer diameter of the first tube body 111a, and may play a limiting role. In some embodiments, the heating element 112 may alternatively be partially spaced apart from the second tube body 111b. The radial size of a section of the heating portion 1120 may be equivalent to the radial size of the second tube body 111b.

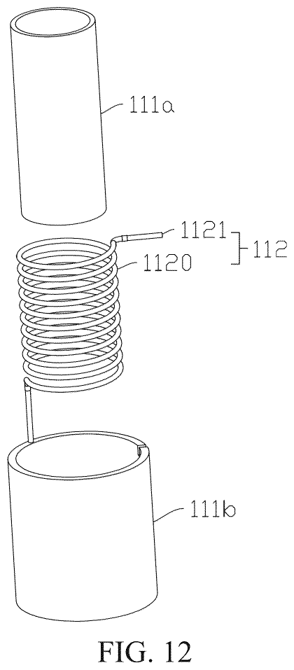

As shown in FIG. 11, in this embodiment, the temperature measurement unit 20 is arranged on the heating structure 11. The temperature measurement unit 20 can be spaced apart from the heating element 112. Further, in this embodiment, as shown in FIG. 12, the temperature measurement unit 20 can be arranged close to the opening 1110 of the housing 111. Being close to here means using the midpoint of the length of the housing 111 as a reference. If a distance from one end of the opening 1110 is shorter, it is close. If a distance from one end of the opening 1110 is longer, it is far away. Specifically, the temperature measurement unit 20 may be arranged on the inner wall or the outer wall of the housing 111. Since the operating temperature of the heating element 112 with light wave infrared is 500° C. to 1300° C., the gap 1114 is reserved between the heating element 112 and the housing 111. Due to the existence of the gap 1114, the surface temperature of the housing 111 can be controlled to be 350° C. or below. Therefore, the temperature measurement unit 20 is arranged on the inner wall or the outer wall of the housing 111, the sensitivity of temperature detection is higher.

Further, the temperature measurement unit 20 includes a first temperature sensor or a second temperature sensor. The first temperature sensor is arranged on the outer wall of the first tube body 111a, and includes a thin film temperature sensor (a resistive temperature measurement film) or a thermistor formed on the housing in a manner of screen printing, PVD, or the like. The second temperature sensor is arranged on the outer wall of the first tube body 111a and includes a thermocouple.

An embodiment of a temperature control method applied to an aerosol generating device of the present application includes the following steps:

Step S1: Obtain a temperature signal of a housing 111. Since the housing 111 is clung to the aerosol generating substrate, heat can be transferred between the housing and the aerosol generating substrate based on a conduction function. By obtaining test data or historical data when the aerosol generating substrate is heated to generate aerosols, a temperature conversion relationship between the temperature of the aerosol generating substrate and the temperature of the housing 111 and a temperature conversion relationship between the temperature of the aerosol generating substrate and the temperature of the heating element can be obtained. Therefore, the actual temperature of the heating element and the actual temperature of the aerosol generating substrate can be derived based on the actual temperature of the housing 111 and the conversion relationships. The temperature of the heating element can be adjusted by obtaining, by the temperature measurement unit 20, the actual temperature of the housing 111 in real time, thus adjusting the temperature of the aerosol generating substrate and controlling the atomization effect of the aerosol generating substrate.

Step S2: Generate an adjustment signal by using a preset algorithm based on the temperature signal and a target temperature. Specifically, the target temperature may be the target temperature of the housing or the target temperature of the heating element. After the target temperature of the aerosol generating substrate is determined, the target temperature of the heating element or the target temperature of the housing 111 may be determined. Therefore, when the target temperature of the housing is used, an adjustment signal generation module uses the preset algorithm such as a PID algorithm, a neural network, or a fuzzy control algorithm to perform a series of calculations to obtain the adjustment signal based on the target temperature of the housing and the measured actual temperature of the housing. When the target temperature of the heating element is used, the adjustment signal generation module obtains the actual temperature of the heating element based on the actual temperature of the housing, and then generates the adjustment signal based on the actual temperature of the heating element and the target temperature of the heating element.

Step S3: Control the heating power of a heating element 112 based on the adjustment signal, to adjust the temperature of the heating element. Specifically, the adjustment signal input to a power control module is a PWM signal. By adjusting the duty cycle of the PWM signal, the heating power of the heating element 112 may be dynamically adjusted. The temperature of the heating element is adjusted to control the wavelength of infrared light, thereby dynamically adjusting the temperature of the aerosol generating substrate and achieving a target atomization effect.

Based on the Planck's law, if the temperature of the heating element 112 is higher, the generated infrared light has the shorter wavelength, the lower penetrability, and more radiated energy. Therefore, the wavelength of the infrared light can be controlled by adjusting the heating power of the heating element 112. When the band range of the infrared light matches the absorption range of the aerosol generating substrate, it can enhance the heat radiation transfer effect. When the band range of the infrared light does not match the absorption range of the aerosol generating substrate, it can reduce the heat radiation transfer effect, thus adjusting the temperature of the aerosol generating substrate.

Further, step S3 includes: in the first stage, the power control module controls the heating power of the heating element based on the adjustment signal to cause the temperature of the heating element to increase from the initial temperature to the first temperature; and in the second stage, the power control module controls the heating power of the heating element based on the adjustment signal to cause the temperature of the heating element to gradually decrease from the first temperature. The first temperature is between 500° C. and 1300° C. That is, the first temperature can be 500° C. or 1300° C., or any value between 500° C. and 1300° C. The duration of the first stage does not exceed 20 seconds, and the duration of the second stage does not exceed 360 seconds.

The first stage can be a preheating stage, the maximum temperature of which is 700° C. to 1300° C. At this temperature, the aerosol generating substrate can be preheated by infrared heat within very short time, thereby ensuring the aerosol amount and the vaping experience for about the first three puffs of a user. Specifically, in the powered-on state, the temperature of the heating element 112 can quickly increase from the room temperature to 1000° C., the duration of which does not exceed 20 seconds. The second stage can be a puff stage after the aerosol generating substrate is preheated and normally generates aerosols inhaled by the user. Its duration generally does not exceed 360 seconds. The temperature of the heating element gradually decreases from about 1000° C. Certainly, it can be understood that in some other embodiments, the heating process of the heating element 112 is not limited to being divided into two stages. For example, the puff stage can be further divided into a middle puff stage and a late puff stage, and corresponding heating temperatures are set.

Further, this embodiment further includes: Step S4: prompting a user to take a puff within a first preset range at the end of the first stage, and stopping heating within a second preset range at the end of the second stage. Specifically, within the first preset range after the preheating stage ends, the user is prompted to take a puff to enhance the user experience. It can be understood that the user can be prompted in a manner of voice, vibration, flashing of an indicator light, or the like. Providing the electrical energy to the heating element is stopped within the second preset range after the puff stage ends, and the heating element is controlled to stop heating. The first preset range and the second preset range are determined based on a temperature control requirement and can be set to 1 to 3 seconds.

Further, this embodiment includes: Step S5: determining whether the temperature signal indicates that a temperature decrease exceeds a threshold within a preset time range; if the temperature decrease exceeds the threshold within the preset time range, increasing a recorded puff count by one; and if temperature decrease does not exceed the threshold within the preset time range, maintaining the recorded puff count unchanged. When the user takes a puff, the temperature of the temperature measurement unit 20 suddenly decreases uncontrollably since an aerosol flow formed by the puffing passes through a heating structure (namely, the aerosol flow flows through the temperature measurement unit). When the aerosol generating device is activated, the recorded puff count is 0. When it is monitored that the temperature signal decreases uncontrollably within a preset time range t and a decrease amplitude is greater than a threshold, it is determined that there is a puffing action, and the recorded puff count is increased by one. The value of t can be specifically determined by analyzing test data or historical data of user puffing.

By implementing the temperature control method applied to the aerosol generating device that is disclosed in the embodiments of the present application, the temperature of the heating element can be controlled by detecting the temperature of the housing, thereby adjusting the temperature of the aerosol generating substrate to be stabilized within a target range, avoiding charring or burning due to the high temperature of the substrate or avoiding insufficient atomization due to the low temperature of the substrate. This can improve the stability of atomization of the aerosol generating substrate, enhance the vaping experience, and enhance the user experience. Further, the method also has a puff detection function.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A temperature control method applied to an aerosol generating device that includes a heating element and a housing, the heating element being configured to be powered on and heat up to generate infrared light to heat an aerosol generating substrate, the heating element and the housing being at least partially spaced apart, the infrared light capable of passing through the housing, the method comprising:
obtaining a temperature signal of the housing;
generating an adjustment signal by using a preset algorithm based on the temperature signal and a target temperature; and
controlling a heating power of the heating element based on the adjustment signal so as to adjust a temperature of the heating element.

2. The temperature control method of claim 1, wherein the controlling the heating power of the heating element based on the adjustment signal to adjust the temperature of the heating element comprises:
in a first stage, controlling the heating power of the heating element based on the adjustment signal to increase the temperature of the heating element from an initial temperature to a first temperature; and
in a second stage, controlling the heating power of the heating element based on the adjustment signal to decrease the temperature of the heating element from the first temperature.

3. The temperature control method of claim 2, wherein the first temperature is between 500° C. and 1300° C.

4. The temperature control method of claim 2, wherein a user is prompted to take a puff within a first preset range at the end of the first stage, and
wherein heating is stopped within a second preset range at the end of the second stage.

5. The temperature control method of claim 2, wherein a duration of the first stage does not exceed 20 seconds, and
wherein a duration of the second stage does not exceed 360 seconds.

6. The temperature control method of claim 1, further comprising:
determining whether the temperature signal indicates that a temperature decrease exceeds a threshold within a preset time period, and:
if the temperature decrease exceeds the threshold within the preset time period, increasing a recorded puff count by one; and
if temperature decrease does not exceed the threshold within the preset time period, maintaining a recorded puff count unchanged.

7. A temperature control system applied to an aerosol generating device that includes a heating element and a housing, the heating element being configured to be powered on and heat up to generate infrared light to heat an aerosol generating substrate, the heating element and the housing wall of the housing being at least partially spaced apart, the infrared light capable of passing through the housing, the temperature control system comprising:
a temperature measurement unit;
a temperature measurement module;
an adjustment signal generation module; and
a power control module,
wherein the temperature measurement unit is arranged on an inner wall or an outer wall of the housing to detect the temperature of the housing,
wherein the temperature measurement module is configured to monitor a temperature of the temperature measurement unit in real time to obtain a temperature signal of the housing,
wherein the adjustment signal generation module is configured to generate an adjustment signal using a preset algorithm based on the temperature signal and the target temperature, and
wherein the power control module is configured to control a heating power of the heating element based on the adjustment signal to adjust a temperature of the heating element.

8. The temperature control system of claim 7, wherein the power control module is configured to:
in a first stage, control the heating power of the heating element based on the adjustment signal so as to increase the temperature of the heating element from an initial temperature to a first temperature; and
in a second stage, control the heating power of the heating element based on the adjustment signal so as to decrease the temperature of the heating element from the first temperature.

9. The temperature control system of claim 8, wherein the first temperature is between 500° C. and 1300° C.,
wherein a duration of the first stage does not exceed 20 seconds, and
wherein a duration of the second stage does not exceed 360 seconds.

10. The temperature control system of claim 7, wherein the temperature measurement unit comprises a first temperature sensor or a second temperature sensor,
wherein the first temperature sensor comprises a thin film temperature sensor or a thermistor, and
wherein the second temperature sensor comprises a thermocouple.

11. The temperature control system of claim 10, wherein the first temperature sensor is connected in series with a first resistor and a temperature measurement switch,
wherein the first temperature sensor is configured to detect the temperature of the housing, and
wherein the temperature measurement switch is configured to be turned on or turned off based on an input driving signal so as to adjust an electrical energy provided to the first temperature sensor.

12. The temperature control system of claim 10, wherein the second temperature sensor is connected to the temperature measurement module,
wherein the second temperature sensor is configured to generate a sensing signal based on the temperature of the housing, and
wherein the temperature measurement module is configured to generate and output the temperature signal based on the sensing signal.

13. The temperature control system of claim 7, wherein the power control module comprises a second resistor, a third resistor, an N-channel metal oxide semiconductor (NMOS) transistor, and a P-channel metal oxide semiconductor (PMOS) transistor,
wherein a gate of the NMOS transistor is connected to the adjustment signal generation module, is configured to receive the adjustment signal, and is grounded through the second resistor,
wherein a source of the NMOS transistor is grounded,
wherein a gate of the PMOS transistor is connected to a drain of the NMOS transistor,
wherein a drain of the PMOS transistor is connected to an input voltage,
wherein a source of the PMOS transistor is connected to the heating element so as to adjust the heating power of the heating element based on the adjustment signal, and
wherein the third resistor is connected between the drain and gate of the PMOS transistor.

14. The temperature control system of claim 7, wherein the heating element is located inside the housing,
wherein the heating element comprises a heating base and an infrared radiation layer coated on the heating base,
wherein the heating element is configured to excite, after being powered on, the infrared radiation layer so as to generate the infrared light, and
wherein the housing is at least partially configured to be inserted into an aerosol generating substrate.

15. The temperature control system of claim 14, wherein the temperature measurement unit comprises a first temperature sensor or a second temperature sensor,
wherein the first temperature sensor comprises a thin film temperature sensor or a thermistor,
wherein the first temperature sensor is arranged on an outer wall of the housing,
wherein the second temperature sensor comprises a thermocouple, and
wherein the second temperature sensor is arranged on an inner wall of the housing.

16. The temperature control system of claim 7, wherein the heating element is arranged at a periphery of the housing in a spacing manner, and
wherein an inside of the housing is hollow and forms a second accommodating cavity configured to accommodate the aerosol generating substrate.

17. The temperature control system of claim 7, wherein the housing comprises a first tube body and a second tube body sleeving a periphery of the first tube body,
wherein a gap is reserved between the first tube body and the second tube body, the gap forming a first accommodating cavity configured to accommodate the heating element,
wherein the heating element is arranged at a periphery of the first tube body and is spaced apart from an outer wall of the first tube body,
wherein a second accommodating cavity configured to heat the aerosol generating substrate is formed on an inner side of the first tube body,
wherein the heating element comprises a heating base and an infrared radiation layer coated on the heating base, and
wherein the heating element is configured to excite, after being powered on, the infrared radiation layer so as to generate the infrared light.

18. The temperature control system of claim 17, wherein the temperature measurement unit comprises a first temperature sensor or a second temperature sensor,
wherein the first temperature sensor comprises a thin film temperature sensor or a thermistor,
wherein the first temperature sensor is arranged on an inner wall of the first tube body,
wherein the second temperature sensor comprises a thermocouple, and
wherein the second temperature sensor is arranged on the outer wall of the first tube body.
